(19) United States
(12) Patent Application Publication
(10) Pub. No.: US 2025/0245447 A1
(43) Pub. Date: Jul. 31, 2025

(54) INFORMATION PROCESSING APPARATUS CAPABLE OF RETRIEVING INFORMATION INDICATING STORAGE LOCATION OF FILE, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: TAKAAKI MIYATA, Ibaraki (JP)

(21) Appl. No.: 18/956,554

(22) Filed: Nov. 22, 2024

(30) Foreign Application Priority Data
Jan. 25, 2024 (JP) 2024-009369

(51) Int. Cl. G06F 40/40

(52) U.S. Cl. CPC G06F 40/40

(57) ABSTRACT

A mechanism that makes it possible to easily retrieve information indicating a storage location of a file without being restricted by how the file has been stored on the network. In an information processing apparatus, a question message using a natural language for inquiring about a storage location of a file is transmitted to a large-scale language model in a large-scale language model server. The large-scale language model is a large-scale language model that retrieves information indicating a storage location of a file based on a degree of similarity of a language vector of a natural language. A response message for notifying the information indicating the storage location of the file, retrieved by the large-scale language model by using the language vector of the natural language of the question message, is received from the large-scale language model.

### BACKGROUND OF THE INVENTION

### Field of the Invention

The present invention relates to an information processing apparatus that is capable of retrieving information indicating a storage location of a file, a method of controlling the information processing apparatus, and a storage medium.

### Description of the Related Art

As one method of natural language retrieval, there is known a method using a large-scale language model. Examples of this method include a method in which a large amount of data using a natural language is converted to language vectors in advance, and a degree of similarity between a question sentence in the natural language and each language vector is calculated, whereby one having a high degree of similarity is set as a retrieval result. Incidentally, in an office of users, such as knowledge workers, there is a difficulty when a user searches for a specific file from a huge amount of files of internal documents of the company. However, if a user searches for a file on the Internet outside the company by using a personal computer (PC), means for searching for a file by using a WEB search engine or the like is available.

However, for example, in a case where a user searches for a file once viewed by the user on a PC, it is sometimes difficult to remember which of a WEB site on the intranet of the company, a file server, and the PC of the user himself/herself is the storage location of this file. Further, even when the user remembers that the file which has been once accessed on the PC is stored in the file server, it is sometimes difficult for the user to remember the location storing this file in the file server. This point is the same also in a case where the user used an image forming apparatus for transmitting a file obtained by scanning internal documents of the company to a file server with which communication can be performed according to the Server Message Block (SMB) or the like. That is, the office can be in a lot of situations where it is difficult for a user to reach the information indicating the storage location of a file.

As a technique related to this, Japanese Laid-Open Patent Publication (Kokai) No. 2023-62251 discloses a technique in which upload of a file to a file server is performed via a graphical user interface (GUI) of a file management system. In the technique disclosed in Japanese Laid-Open Patent Publication (Kokai) No. 2023-62251, the file management system extracts words from a file name or contents of a file, and in a case where a question is received from a user, the file management system outputs a file from which words associated with the question are extracted, to the GUI in the form of an icon.

However, in the technique disclosed in Japanese Laid-Open Patent Publication (Kokai) No. 2023-62251, only a specific file which has been uploaded via the file management system is a retrieval target. Therefore, the technique disclosed in Japanese Laid-Open Patent Publication (Kokai) No. 2023-62251 has a problem that in a case where a file has been uploaded via a browser or a case where a file has been stored in the file server not from a PC but from an image forming apparatus according to the SMB, this internal file of the company cannot be retrieved.

### SUMMARY OF THE INVENTION

The present invention provides a mechanism that makes it possible to easily retrieve information indicating a storage location of a file without being restricted by how the file has been stored on a network.

In a first aspect of the present invention, there is provided an information processing apparatus, including at least one processor, and a memory coupled to the at least one processor storing instructions that, when executed by the processor, cause the processor to function as: a message transmission unit configured to transmit a question message using a natural language for inquiring about a storage location of a file to a large-scale language model in a server, wherein the large-scale language model is a large-scale language model that retrieves information indicating a storage location of a file based on a degree of similarity of a language vector of the natural language, and a message reception unit configured to receive a response message for notifying the information indicating the storage location of the file from the large-scale language model, which has been retrieved by the large-scale language model by using the language vector of the natural language of the question message.

In a second aspect of the present invention, there is provided a method of controlling an information processing apparatus, including transmitting a question message using a natural language for inquiring about a storage location of a file to a large-scale language model in a server, wherein the large-scale language model is a large-scale language model that retrieves information indicating a storage location of a file based on a degree of similarity of a language vector of the natural language, and receiving a response message for notifying the information indicating the storage location of the file from the large-scale language model, which has been retrieved by the large-scale language model by using the language vector of the natural language of the question message.

According to the present invention, it is possible to easily retrieve information indicating a storage location of a file without being restricted by how the file has been stored on a network.

Further features of the present invention will become apparent from the following description of exemplary embodiments (with reference to the attached drawings).

### BRIEF DESCRIPTION OF THE DRAWINGS

FIG. 1 is a diagram showing a configuration of an information processing system according to a first embodiment.

FIG. 2 is a block diagram showing an example of a hardware configuration which is common to a user terminal, a file server, and a large-scale language model server in the first embodiment and a second embodiment.

FIG. 3A is a diagram showing a database constructed in the large-scale language model server in the first embodiment.

FIG. 3B is a flowchart showing operations of the large-scale language model server in a case where when a user terminal performs an operation on a file, a uniform resource locator (URL) of the file is transmitted to the large-scale language model server by a resident program of the user terminal in the first embodiment.

FIG. 3C is a flowchart showing operations of the large-scale language model server in a case where a question sentence and a user identification (ID) are transmitted to the large-scale language model server by the resident program of the user terminal via a chat program in the first embodiment.

FIG. 4A is a flowchart showing operations of the user terminal in a case where the user terminal performs an operation on a file for the user terminal itself or the file server in the first embodiment.

FIG. 4B is a diagram showing a screen displayed on a display section of the user terminal when the user terminal transmits a question sentence about a storage location of a file to the large-scale language model server, in the first embodiment.

FIG. 4C is a flowchart showing operations of the user terminal in a case where a question sentence and a user ID are transmitted to the large-scale language model server by the resident program of the user terminal via the chat program, in the first embodiment.

FIG. 5 is a diagram showing a configuration of an information processing system according to the second embodiment.

FIG. 6 is a diagram showing an example of a hardware configuration of an image forming apparatus in the second embodiment.

FIG. 7A is a diagram showing a database constructed in the large-scale language model server in the second embodiment.

FIG. 7B is a flowchart showing operations of the large-scale language model server in a case where when the image forming apparatus performs an operation on a file, a URL of the file is transmitted to the large-scale language model server by a resident program of the image forming apparatus, in the second embodiment.

FIG. 7C is a flowchart showing operations of the large-scale language model server in a case where a question sentence and a user ID are transmitted to the large-scale language model server by the resident program of the image forming apparatus via the chat program, in the second embodiment.

FIG. 7D is a flowchart showing operations of the large-scale language model server in a case where the large-scale language model server periodically checks whether or not a file exists at a URL in each data element of the database, in the second embodiment.

FIG. 8A is a flowchart showing operations of the image forming apparatus in a case where the image forming apparatus performs an operation on a file for the image forming apparatus itself, the file server, or the user terminal, in the second embodiment.

FIG. 8B is a diagram showing a screen displayed on a console section of the image forming apparatus when the image forming apparatus transmits a question sentence about a storage location of a file to the large-scale language model server, in the second embodiment.

FIG. 8C is a flowchart showing operations of the image forming apparatus in a case where a question sentence and a user ID are transmitted to the large-scale language model server by the resident program of the image forming apparatus via the chat program, in the second embodiment.

### DESCRIPTION OF THE EMBODIMENTS

The present invention will now be described in detail below with reference to the accompanying drawings showing embodiments thereof. However, the following description of the configuration of the embodiments is given by way of example, and the scope of the present invention is not limited to the described configuration of the embodiments. For example, each component of the configuration of the present invention can be replaced by a desired component which can exhibit the same function. Further, a desired component can be added. Further, two or more desired components (features) of the embodiments can be combined.

The outline of a first embodiment will be described below. In the first embodiment, in an intranet in a company, when a user terminal which is a PC performs an operation on a file in a file server, a large-scale language model learns the contents of the file. After that, the user terminal asks a question about a storage location of the file by indicating contents of the file to the large-scale language model by using a natural language. In response to this, the large-scale language model answers the URL of the file, of which the location is questioned, to the user terminal using the natural language.

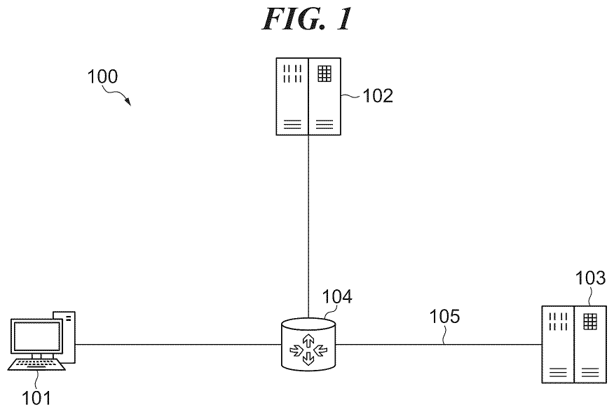

In the present specification of the invention, the “operation on a file” refers to reading a file, writing a file, creation of a new file, deletion of a file, execution of a file, and so forth. Note that creation of a new file includes an operation of newly creating a file and an operation of storing a newly created file. Further, in the present specification, the configuration of the URL also includes one which is only formed by a file path in a device, such as a user terminal. The first embodiment will be described below with reference to FIGS. 1 to 4C.

FIG. 1 is a diagram showing a configuration of an information processing system 100 according to the first embodiment. As shown in FIG. 1, the information processing system 100 includes a user terminal 101, a file server 102, a large-scale language model server 103, a router 104, and a local area network 105 (hereinafter abbreviated as the “network 105”). In the information processing system 100, the user terminal 101 (information processing apparatus), the file server 102, and the large-scale language model server 103 (server) can intercommunicate via the router 104 and the network 105. Note that each of the user terminal 101 and the file server 102 can be not only singly connected to the network 105 as a single unit but also can be connected in plurality to the same as a plurality of units.

The network 105 is constructed by cables laid on floors in the company, e.g. as the Ethernet. The router 104 has a role of routing the plurality of networks 105. The router 104 can treat networks at physically remote sites in the company as an identical network by using a technique of virtual private network (VPN) or the like. The file server 102 is installed in each department or each site in the company, as an SMB server used by all members of the company or permitted users to share files. Each file in the file server 102 is uniquely identified by a URL. Therefore, the user terminal 101 and the large-scale language model server 103 can perform an operation on a file in the file server 102 by using the URL.

The user terminal 101 is a terminal, such as a PC, a tablet terminal, or a smartphone, which can be connected to the network 105 by a user. As a typical example, the user terminal 101 has software, including a browser, a word processor, and a spreadsheet, and can read, write, delete, and execute a file in the file server 102 on the network 105 from these software programs. Further, the user terminal 101 can store a newly created file in the file server 102 on the network 105 from the above-mentioned software. Further, on the user terminal 101, a resident program operates.

In the user terminal 101, the resident program detects an operation on a file in the file server 102, which is performed from the user terminal 101. Further, in a case where the detected operation on the file is performed for a document file described in a natural language or an image file including the natural language, the resident program transmits a URL and the like of the file to a large-scale language model in the large-scale language model server 103. Further, a chat program which can communicate with the large-scale language model by using a natural language also operates on the user terminal 101.

The file server 102 has a function of providing a file in response to a request from the user terminal 101 or the large-scale language model server 103. In the present specification of the invention, a communication protocol used when the file server 102 provides a file to the user terminal 101 or the large-scale language model server 103 is the SMB as mentioned above. However, the communication protocol is not particularly limited, but, for example, Hyper Text Transfer Protocol (HTTP) or the Web-based Distributed Authoring and Versioning (WebDAV) can be used, or another communication protocol can also be used.

In the large-scale language model server 103, the large-scale language model acquires a file located at the URL transmitted from the user terminal 101. In a case where the acquired file is a document file described in a natural language, the large-scale language model subjects the contents of the natural language to language vectorization. Further, in a case where the acquired file is an image file, the large-scale language model extracts a natural language included in the image by optical character recognition (OCR) or a machine learning method and subjects the contents of the extracted natural language to language vectorization. Further, the large-scale language model constructs a database including data elements each formed by a combination of at least a URL and a language vector, in the large-scale language model server 103. Further, when a question sentence using a natural language about a storage location of a file is transmitted from the user terminal 101, the large-scale language model subjects the question sentence to language vectorization and calculates a degree of similarity between the language vectors of the question sentence and the language vectors in the database. Further, the large-scale language model transmits a URL combined with a language vector which is the highest in calculated degree of similarity to the user terminal 101 as a response.

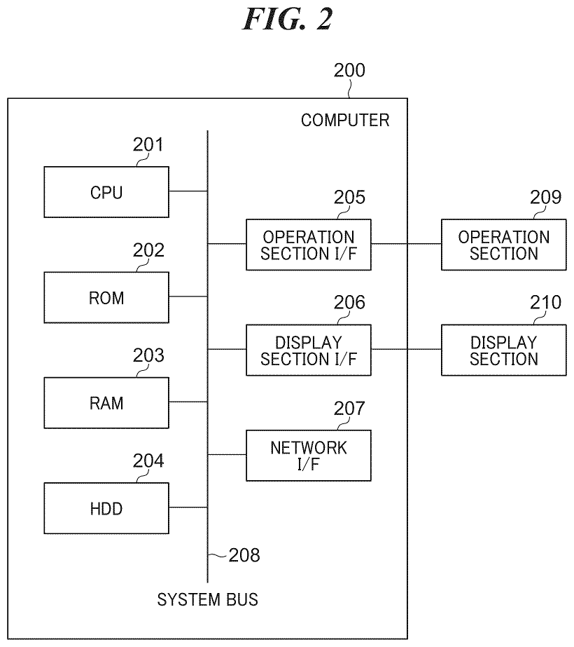

FIG. 2 is a block diagram showing an example of a hardware configuration of a computer 200. The user terminal 101, the file server 102, and the large-scale language model server 103 each have a mechanism of a computer, and hence they have the common hardware configuration. So, the hardware configuration which is common to the user terminal 101, the file server 102, and the large-scale language model server 103 will be described with reference to the hardware configuration of the computer 200 shown in FIG. 2. As shown in FIG. 2, in the computer 200, a central processing unit (CPU) 201, a read only memory (ROM) 202, a random access memory (RAM) 203, a hard disk drive (HDD) 204, an operation section interface (I/F) 205, a display section I/F 206, and a network I/F 207 are connected to a system bus 208.

The CPU 201 starts an operating system (OS) by a boot program stored in the ROM 202. The CPU 201 executes a variety of processes on the activated OS by executing application programs stored in the HDD 204. As a work area for the CPU 201, the RAM 203 is used. In the HDD 204, the application programs and data managed by the application programs are stored. The network I/F 207 is connected to the network 105.

Each application program inputs and outputs information to and from each device on the network 105 via the network 105. The operation section I/F 205 is an interface with an operation section 209 comprised of a mouse and a keyboard, and sends operation information input by a user on the operation section 209 to the CPU 201. The display section I/F 206 outputs display screen data generated by the CPU 201 to a display section 210 comprised of a display. User interface is realized by the operation section 209 and the display section 210.

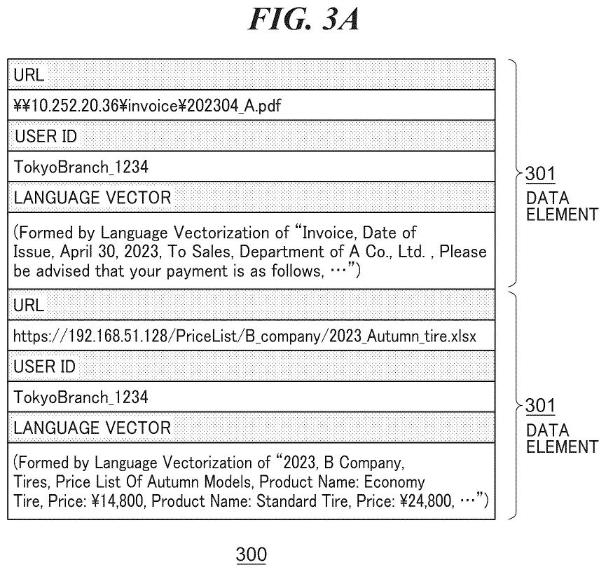

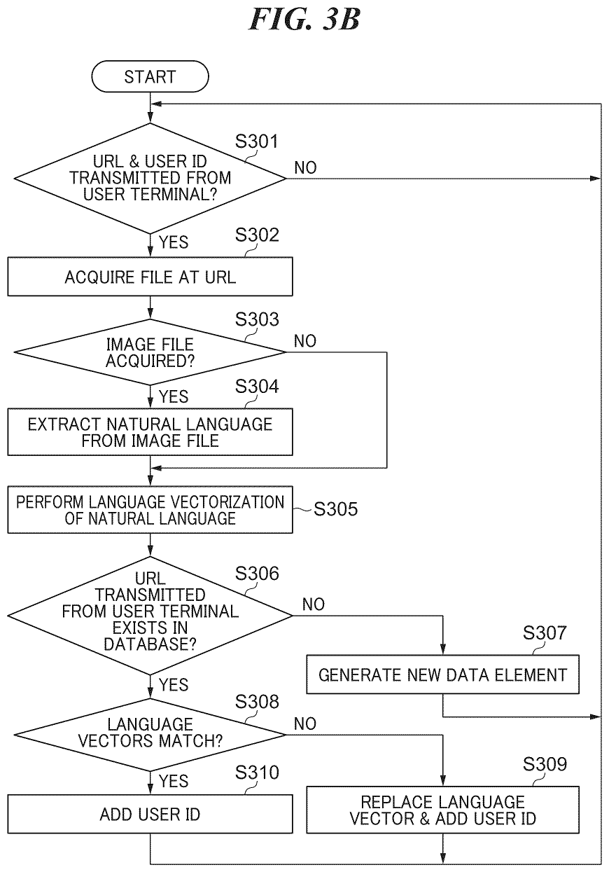

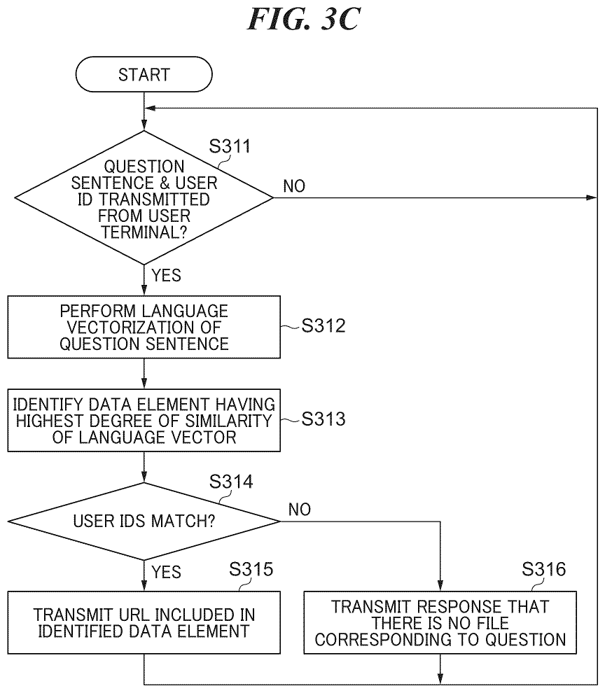

Details of the large-scale language model server 103 will be described below with reference to FIGS. 3A to 3C. FIG. 3A is a diagram showing a database 300 constructed in the large-scale language model server 103. As shown in FIG. 3A, the database 300 has a plurality of data elements 301. Each data element 301 includes three information items. The three information items include a URL indicating a storage location of one file, a user ID of the user terminal 101 on which an operation on this file was performed, and a language vector converted from the contents of this file. Note that in the database 300, whenever a URL is transmitted from the user terminal 101 to the large-scale language model in the large-scale language model server 103, update of the data element 301 and addition of a new data element 301 occur.

FIGS. 3B and 3C are flowcharts each showing operations of the large-scale language model in the large-scale language model server 103. Note that in the following description, the large-scale language model in the large-scale language model server 103 is sometimes abbreviated as the large-scale language model server 103. FIG. 3B is a flowchart showing the operations of the large-scale language model server 103 in a case where when the user terminal 101 performs an operation on a file, a URL of the file is transmitted to the large-scale language model server 103 by the resident program of the user terminal 101. The operations indicated by the flowchart in FIG. 3B are realized by the CPU 201 that loads an associated program of the large-scale language model, which is stored in the HDD 204, into the RAM 203 and executes the loaded program in the large-scale language model server 103.

In a step S301, the CPU 201 of the large-scale language model server 103 determines whether or not a URL and a user ID have been transmitted from the user terminal 101. If it is determined by the CPU 201 of the large-scale language model server 103 that no URL and no user ID have been transmitted from the user terminal 101, the process returns to the step S301. With this, the CPU 201 of the large-scale language model server 103 is in a state waiting for transmission of a URL and a user ID from the user terminal 101. On the other hand, if it is determined by the CPU 201 of the large-scale language model server 103 that a URL and a user ID have been transmitted from the user terminal 101, the process proceeds to a step S302. In the step S302, the CPU 201 (acquisition unit) of the large-scale language model server 103 acquires a file located at the URL transmitted from the user terminal 101.

In a step S303, the CPU 201 of the large-scale language model server 103 determines whether or not the acquired file is an image file. If it is determined by the CPU 201 of the large-scale language model server 103 that the acquired file is an image file, the process proceeds to a step S304. On the other hand, if it is determined by the CPU 201 of the large-scale language model server 103 that the acquired file is not an image file, the process proceeds to a step S305. In the step S304, the CPU 201 of the large-scale language model server 103 extracts a natural language from the image file, i.e. the acquired file. In the step S305, the CPU 201 of the large-scale language model server 103 subjects the natural language included in the acquired file or the natural language extracted from the acquired file to language vectorization. With this, the CPU 201 of the large-scale language model server 103 acquires the language vector of the natural language included in the acquired file or that of the natural language extracted from the acquired file.

The process from the next step is operations performed for the database 300 by the large-scale language model server 103. In a step S306, the CPU 201 of the large-scale language model server 103 determines whether or not the URL transmitted from the user terminal 101 exists in the database 300. This determination is performed by the CPU 201 of the large-scale language model server 103 searching the URLs included in all of the data elements 301 in the database 300. If it is determined by the CPU 201 of the large-scale language model server 103 that the URL transmitted from the user terminal 101 does not exist in the database 300, the process proceeds to a step S307. On the other hand, if it is determined by the CPU 201 of the large-scale language model server 103 that the URL transmitted from the user terminal 101 exists in the database 300, the process proceeds to a step S308.

In the step S307, the CPU 201 of the large-scale language model server 103 generates a new data element 301 in the database 300. At this time, the CPU 201 of the large-scale language model server 103 combines the language vector acquired in the step S305, and the URL and the user ID, which are transmitted from the user terminal 101, and causes this combination to be included in the new data element 301. After that, the process returns to the step S301. In the step S308, the CPU 201 of the large-scale language model server 103 determines whether or not the language vector included in the data element 301, together with the URL transmitted from the user terminal 101, matches the language vector acquired in the step S305.

If it is determined by the CPU 201 of the large-scale language model server 103 that the language vector included in the data element 301, together with the URL transmitted from the user terminal 101, does not match the language vector acquired in the step S305, the process proceeds to a step S309. On the other hand, if it is determined by the CPU 201 of the large-scale language model server 103 that the language vector included in the data element 301, together with the URL transmitted from the user terminal 101, matches the language vector acquired in the step S305, the process proceeds to a step S310. In the step S309, the CPU 201 of the large-scale language model server 103 replaces the language vector combined with the URL transmitted from the user terminal 101 in the data element 301, with the language vector acquired in the step S305.

Further, in a case where the user ID combined with the URL transmitted from the user terminal 101 in the data element 301 is different from the user ID transmitted from the user terminal 101 together with this URL, the CPU 201 of the large-scale language model server 103 adds the user ID. When adding the user ID, the user ID transmitted from the user terminal 101 together with the URL is added to the data element 301 including the URL transmitted from the user terminal 101. After that, the process returns to the step S301. In the step S310, the CPU 201 of the large-scale language model server 103 adds the user ID, similarly to the step S309. Note that in the step S310, replacement of the language vector in the step S309 is not performed. After that, the process returns to the step S301.

FIG. 3C is a flowchart showing the operations of the large-scale language model server 103 in a case where a question sentence and a user ID are transmitted to the large-scale language model server 103 by the resident program of the user terminal 101 via the chat program. Note that the question sentence in the first embodiment is a sentence generated by using a natural language and refers to a sentence provided by a user to ask a question about a storage location of a file through indication of the contents of the file. The operations indicated by the flowchart in FIG. 3C are realized by the CPU 201 that loads an associated program of the large-scale language model, which is stored in the HDD 204, into the RAM 203 and executes the loaded program in the large-scale language model server 103.

In a step S311, the CPU 201 of the large-scale language model server 103 determines whether or not a question sentence and a user ID have been transmitted from the user terminal 101. If it is determined by the CPU 201 of the large-scale language model server 103 that a question sentence and a user ID have not been transmitted from the user terminal 101, the process returns to the step S311. With this, the CPU 201 of the large-scale language model server 103 is in a state waiting for transmission of a question sentence and a user ID from the user terminal 101. On the other hand, if it is determined by the CPU 201 of the large-scale language model server 103 that a question sentence and a user ID have been transmitted from the user terminal 101, the process proceeds to a step S312.

In the step S312, the CPU 201 of the large-scale language model server 103 subjects the question sentence transmitted from the user terminal 101 to language vectorization. With this, the CPU 201 of the large-scale language model server 103 acquires the language vector of the question sentence transmitted from the user terminal 101. In a step S313, the CPU 201 of the large-scale language model server 103 calculates a degree of similarity between a language vector included in each data element 301 and the language vector acquired in the step S312, for all of the data elements 301 in the database 300. Further, the CPU 201 (retrieval unit) of the large-scale language model server 103 identifies a data element 301 having the highest degree of similarity of the language vector, out of all the data elements 301 in the database 300. Note that as the similarity calculation method, any suitable calculation method, including a cosine similarity calculation method, can be used insofar as it can calculate the degree of similarity between language vectors.

In a step S314, the CPU 201 of the large-scale language model server 103 determines whether or not a user ID included in the data element 301 identified in the step S313 matches the user ID transmitted from the user terminal 101. With this determination, the security of a result of retrieval of the storage location of the file of an internal document of the company can be ensured by the user ID. If it is determined by the CPU 201 of the large-scale language model server 103 that the user ID included in the data element 301 identified in the step S313 matches the user ID transmitted from the user terminal 101, the process proceeds to a step S315. On the other hand, if it is determined by the CPU 201 of the large-scale language model server 103 that the user ID included in the data element 301 identified in the step S313 does not match the user ID transmitted from the user terminal 101, the process proceeds to a step S316.

In the step S315, the CPU 201 (response transmission unit) of the large-scale language model server 103 transmits a response sentence (response message) notifying a URL included in the data element 301 identified in the step S313 to the user terminal 101. Note that the response sentence is a sentence generated by the large-scale language model using the natural language in response to the question about the storage location of the file from the user. After that, the process returns to the step S311. In the step S316, the CPU 201 of the large-scale language model server 103 transmits a response sentence (absence message) notifying that there is no file corresponding to the question from the user terminal 101, to the user terminal 101. After that, the process returns to the step S311.

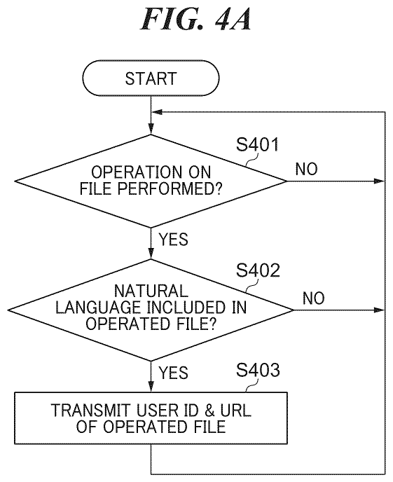

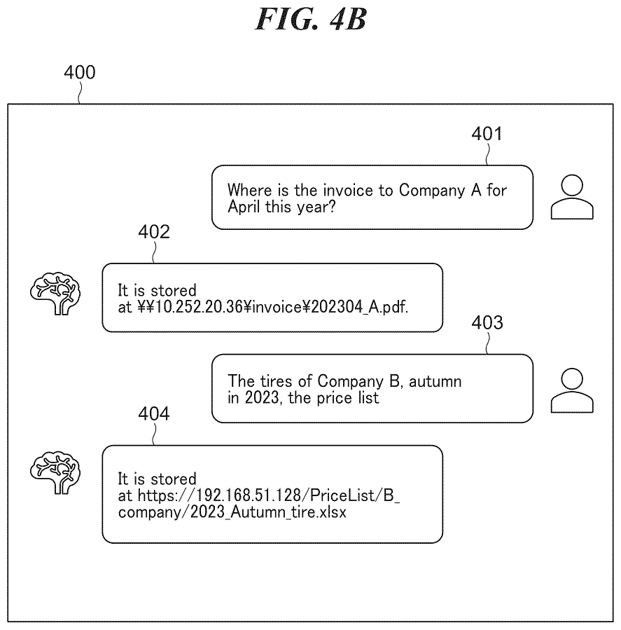

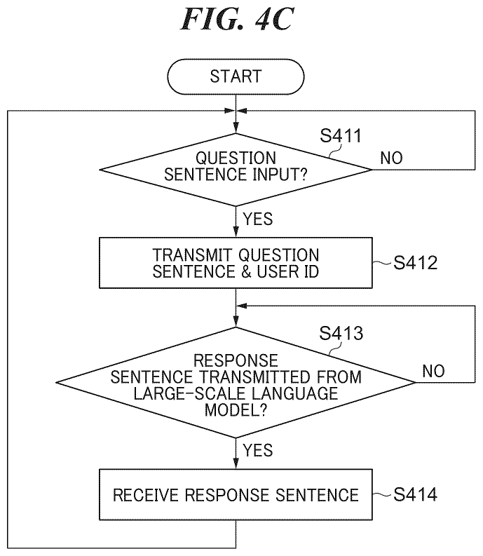

The operations of the user terminal 101 will be described below with reference to FIGS. 4A to 4C. FIG. 4A is a flowchart showing the operations of the user terminal 101 in a case where the user terminal 101 performs an operation on a file for the user terminal 101 itself or the file server 102. The operations indicated by the flowchart in FIG. 4A are realized by the CPU 201 that loads an associated resident program stored in the HDD 204 into the RAM 203 and executes the loaded program in the user terminal 101.

In a step S401, the CPU 201 of the user terminal 101 determines whether or not an operation on a file has been performed for the user terminal 101 itself or the file server 102. If it is determined by the CPU 201 of the user terminal 101 that an operation on a file has been performed for the user terminal 101 itself or the file server 102, the process proceeds to a step S402. On the other hand, if it is determined by the CPU 201 of the user terminal 101 that an operation on a file has been performed for neither the user terminal 101 itself nor the file server 102, the process returns to the step S401. With this, the CPU 201 of the user terminal 101 is in a state waiting for an operation on a file to be performed for the user terminal 101 itself or the file server 102.

In the step S402, the CPU 201 of the user terminal 101 determines whether or not a natural language is included in the file determined as the operated file in the step S401. The determination method used in the step S402 is not particularly limited, but a determination method simply based on a file extension, a determination method based on presence/absence of a character code, or a method of determining a file type by detecting a specific binary string attached to a beginning part of the file can be used. If it is determined by the CPU 201 of the user terminal 101 that a natural language is not included in the file determined as the operated file in the step S401, the process returns to the step S401. On the other hand, if it is determined by the CPU 201 of the user terminal 101 that a natural language is included in the file determined as the operated file in the step S401, the process proceeds to a step S403.

In the step S403, the CPU 201 (transmission unit) of the user terminal 101 transmits the user ID and the URL of the file determined as the operated file in the step S401 to the large-scale language model server 103. After that, the process returns to the step S401. Note that the method of transmission to the large-scale language model server 103 is not particularly limited, but for example, the HTTP POST method, the File Transfer Protocol (FTP) PUT method, or the like can be used. This point is the same in a second embodiment, described hereinafter.

FIG. 4B is a diagram showing a screen 400 displayed on the display section 210 of the user terminal 101 when the user terminal 101 transmits a question sentence about a storage location of a file to the large-scale language model server 103. Note that in the user terminal 101, the screen 400 is displayed on the display section 210 by the chat program. An example of a text chat exchanged between a user operating the user terminal 101 and the large-scale language model in the large-scale language model server 103 will be described below with reference to the screen 400 shown in FIG. 4B.

As shown in the screen 400 in FIG. 4B, through a chat comment 401, the user asks a question about the storage location of an invoice to Company A for April this year to the large-scale language model, in a sentence in a conversational tone using a natural language. In response to this question, through a chat comment 402, the large-scale language model makes a response for notifying the user of a URL of a file in a shared folder in the file server 102 as the storage location of the invoice to Company A for April this year, in a sentence in the conversational tone using the natural language. Note that although the URL in the chat comment 402 is formed by a file path of Windows (registered trademark), the URL can be a URL based on the scheme of the SMB depending on a communication environment. This point is the same in the second embodiment, described hereinafter.

Further, through a chat comment 403, the user asks a question about the storage location of a price list of tires of Company B in the autumn of 2023 to the large-scale language model, by using spaced character strings in the natural language. In response to this question, through a chat comment 404, the large-scale language model makes a response for notifying the user of a URL of a HTTP server, not shown, as the storage location of the price list of tires of Company B in the autumn of 2023, in a sentence in the conversational tone using the natural language. Note that a communication protocol indicated by the scheme of the URL in the chat comment 404 is the HTTP.

Therefore, the HTTP server, not shown, provides the file to the user terminal 101 and the large-scale language model server 103 via the network 105 by the HTTP communication protocol. Further, similar to the file server 102, the HTTP server, not shown, has the hardware configuration shown in FIG. 2. Thus, the user operating the user terminal 101 can easily retrieve the storage location of a file of an internal document of the company by text chat with the large-scale language model in the large-scale language model server 103. Note that this point is the same in the second embodiment, described hereinafter.

FIG. 4C is a flowchart showing the operations of the user terminal 101 in a case where a question sentence and a user ID are transmitted to the large-scale language model server 103 by the resident program of the user terminal 101 via the chat program. The operations indicated by the flowchart in FIG. 4C (method of controlling the information processing apparatus) are realized by the CPU 201 (computer) that loads an associated resident program (program) stored in the HDD 204 into the RAM 203 and executes the loaded program in the user terminal 101.

In a step S411, the CPU 201 of the user terminal 101 determines whether or not a question sentence has been input to the user terminal 101. If it is determined by the CPU 201 of the user terminal 101 that a question sentence has been input to the user terminal 101, the process proceeds to a step S412. At this time, the CPU 201 of the user terminal 101 displays the question sentence input to the user terminal 101 on the display section 210 as indicated, for example, by the chat comments 401 and 403 on the screen 400 shown in FIG. 4B. On the other hand, if it is determined by the CPU 201 of the user terminal 101 that a question sentence has not been input to the user terminal 101, the process returns to the step S411. With this, the CPU 201 of the user terminal 101 is in a state waiting for an input of a question sentence to the user terminal 101. In the step S412, the CPU 201 (message transmission unit) of the user terminal 101 transmits the question sentence (question message) and the user ID to the large-scale language model server 103.

In a step S413, the CPU 201 of the user terminal 101 determines whether or not a response sentence has been transmitted from the large-scale language model server 103. If it is determined by the CPU 201 of the user terminal 101 that a response sentence has not been transmitted from the large-scale language model server 103, the process returns to the step S413. With this, the CPU 201 of the user terminal 101 is in a state waiting for transmission of a response sentence from the large-scale language model server 103. On the other hand, if it is determined by the CPU 201 of the user terminal 101 that a response sentence has been transmitted from the large-scale language model server 103, the process proceeds to a step S414. In the step S414, the CPU 201 (message reception unit) of the user terminal 101 receives the response sentence from the large-scale language model server 103. At this time, the CPU 201 of the user terminal 101 displays the response sentence transmitted from the large-scale language model server 103 on the display section 210 as indicated, for example, by the chat comments 402 and 404 on the screen 400 shown in FIG. 4B. After that, the process returns to the step S411.

As described above, in the information processing system 100, the resident program of the user terminal 101 detects that an operation on a file has occurred for the file server 102. At this time, the resident program transmits a URL of the file concerning the detected operation to the large-scale language model server 103. In the large-scale language model server 103, the large-scale language model acquires a file located at the URL transmitted from the user terminal. Further, the large-scale language model constructs the database 300 having the data elements 301 each formed by a combination of a language vector of the natural language included in the acquired file and the URL.

After that, the user transmits a question sentence in the natural language from the user terminal 101 to the large-scale language model in the form of the text chat so as to retrieve the storage location of the file. In this case, the large-scale language model calculates a degree of similarity between the language vector of the question sentence and the language vector in each data element 301 of the database 300. Further, the large-scale language model transmits a response sentence for notifying the user of the URL in the data element 301 which is the highest in the calculated degree of similarity, by using the natural language, to the user terminal 101 in the form of the text chat. With this, the user terminal 101 receives the response sentence from the large-scale language model and displays the received response sentence on the display section 210, thereby notifying the user of a retrieval result optimum for the question sentence.

Thus, in the information processing system 100 and the user terminal 101, it is possible to easily retrieve a URL as the information indicating a storage location of a file, without being restricted by how the file has been stored on the network 105.

The outline of the second embodiment will be described below. In the second embodiment, when an image forming apparatus performs an operation on a file on the file server in the intranet of the company, the large-scale language model learns the contents of this file. At this time, the large-scale language model learns not only the contents of the file, but also metadata including information, such as a time at which the operation was performed, who performed the operation, what type of the operation has been performed on the file.

Incidentally, the intranet in a company in recent years is often designed such that a common user ID is used for all devices in the company including different hosts, i.e. an image forming apparatus, a file server, and a PC. For example, when a user performs an operation of card authentication on the image forming apparatus, and then transmits a file generated by scanning an internal document, to the file server, it is possible to generate a new file in the file server using the same user authority as that for the PC. This makes it possible to prompt the large-scale language model to newly add a data element to the database from both of the image forming apparatus and the PC. Further, it is possible to ask a question about a storage location of a file to the large-scale language model by using a natural language from a device on the network, which is different from the image forming apparatus or the PC which has prompted addition of the new data element.

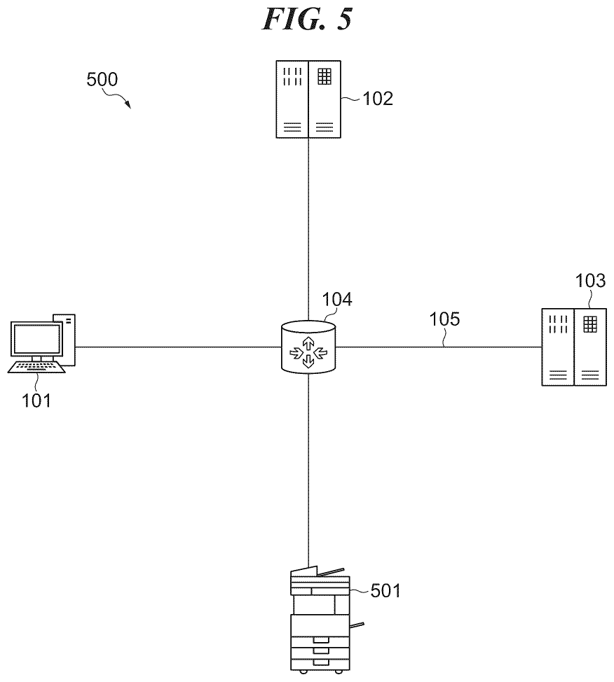

Further, the large-scale language model checks whether or not a file exists at a URL in each data element of the database periodically, e.g. at intervals of 12 hours. The large-scale language model checks, with respect to a URL at which no file exists, whether or not a file having the same contents as the file exists in a directory in the vicinity of the URL. If a file having the same contents as the file is confirmed to exist in a directory in the vicinity of this URL at which no file exists, the large-scale language model replaces the URL at which no file exists with the URL of the file having the same contents in the data element in the database. The second embodiment will be described below with reference to FIGS. 5 to 8C. The following description will be given mainly of different points from the first embodiment. Note that in the second embodiment, the same component and processing as those in the first embodiment are denoted using the same reference numerals as those in the first embodiment, and detailed description thereof is omitted.

FIG. 5 is a diagram showing a configuration of an information processing system 500 according to the second embodiment. As shown in FIG. 5, the information processing system 500 according to the second embodiment includes the user terminal 101, the file server 102, the large-scale language model server 103, the router 104, the network 105, and an image forming apparatus 501 (information processing apparatus). In the information processing system 500, the user terminal 101, the file server 102, the large-scale language model server 103, and the image forming apparatus 501 can intercommunicate via the router 104 and the network 105. Therefore, the information processing system 500 according to the second embodiment is formed by connecting the image forming apparatus 501 to the network 105 of the above-described information processing system 100 according to the first embodiment. Therefore, detailed description of the configuration of the information processing system 500 according to the second embodiment and the hardware configurations of the user terminal 101 and so forth are omitted, and in the following description, a hardware configuration of the image forming apparatus 501 will be described in detail.

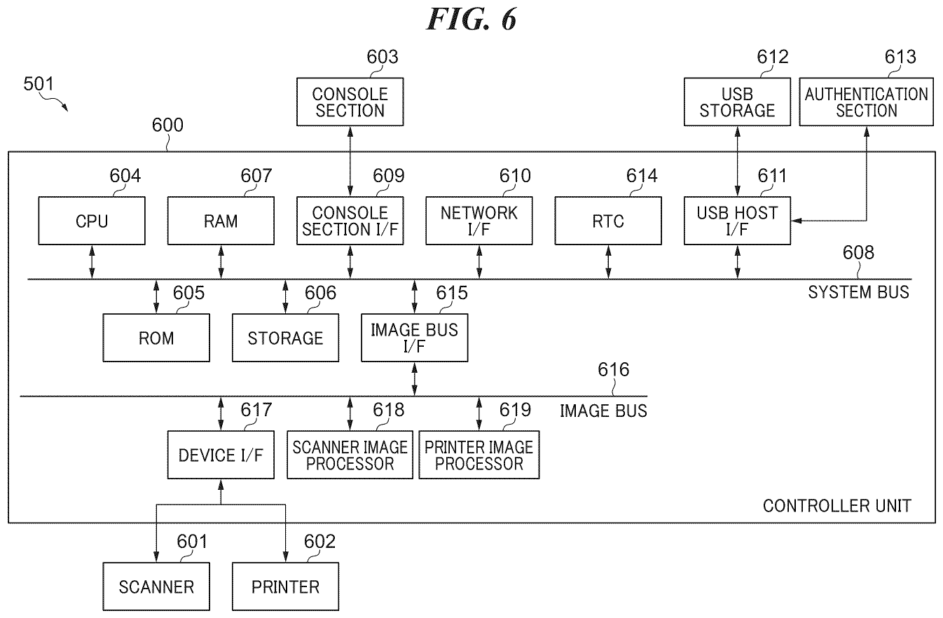

FIG. 6 is a diagram showing an example of the hardware configuration of the image forming apparatus 501.

As shown in FIG. 6, the image forming apparatus 501 includes a controller unit 600. To the controller unit 600, a scanner 601 as an image input device, a printer 602 as an image output device, and a console section 603 are connected. The controller unit 600 performs control for realizing a copy function of printing and outputting image data read by the scanner 601, by using the printer 602. The controller unit 600 includes a CPU 604. The CPU 604 starts an OS by a boot program stored in a ROM 605. The CPU 604 executes a variety of processing operations by executing programs stored in a storage 606.

Further, in the ROM 605, set values for making a variety of settings of the image forming apparatus 501 are also stored. These set values include an inference flag indicating whether the image forming apparatus 501 operates in an inference mode or in a learning mode. As a work area for the CPU 604, a RAM 607 is used. The RAM 607 provides not only the work area, but also an image memory area for temporarily storing image data. In the storage 606, the programs, image data, and further, information on a sheet feed capacity including the maximum feedable number of sheets of the image forming apparatus 501 are stored.

The CPU 604 is connected to the other modules via a system bus 608. A console section I/F 609 is an interface with the console section 603 having a touch panel and outputs image data to be displayed on the console section 603 to the console section 603. Further, the console section I/F 609 sends information input by a user on the console section 603 to the CPU 604. A network I/F 610 is an interface for connecting the image forming apparatus 501 to the network 105. A universal serial bus (USB) host I/F 611 is an interface for communicating with a USB storage 612. The USB host I/F 611 also functions as an output section for causing data stored in the storage 606 to be stored into the USB storage 612. Further, the USB host I/F 611 inputs data stored in the USB storage 612 and sends the input data to the CPU 604. The USB storage 612 is an external storage device for storing data and can be removably attached to the USB host I/F 611.

Further, an authentication section 613 can also be connected to the USB host I/F 611. A representative example of the authentication section 613 is a card reader. When a user holds an authentication card held by the user over the card reader as the authentication section 613, operations performed on the image forming apparatus 501 thereafter are regarded as the operation performed by a person indicated by the user ID stored in the authentication cared held over the card reader. Note that in the authentication card held by a user, a user ID common to all devices in the company is stored as mentioned above, but a different user ID can be stored for each device or for each user. Therefore, as the authentication section 613, not only the card reader, but also a device that performs biometric authentication based on a fingerprint or vein can be used. Thus, a plurality of USB devices including the USB storage 612 and the authentication section 613 can be connected to the USB host I/F 611.

A real-time clock (RTC) 614 controls time information. The time information controlled by the RTC 614 is used for acquiring a time at which automatic shutdown is performed, recording a job input time, and so forth. An image bus I/F 615 is a bus bridge for connecting the system bus 608 and an image bus 616 via which image data is transferred at high speed, and for converting a data format. The image bus 616 is implemented by a peripheral component interconnect (PCI) bus, an IEEE 1394 bus, or the like. To the image bus 616, a device I/F 617, a scanner image processor 618, and a printer image processor 619 are connected. To the device I/F 617, the scanner 601 and the printer 602 are connected. The device I/F 617 performs synchronous-to-asynchronous or asynchronous-to-synchronous conversion of image data. The scanner image processor 618 performs correction, processing, and editing on input image data. The printer image processor 619 performs correction adapted to the printer 602, resolution conversion, and so forth on the image data to be printed out.

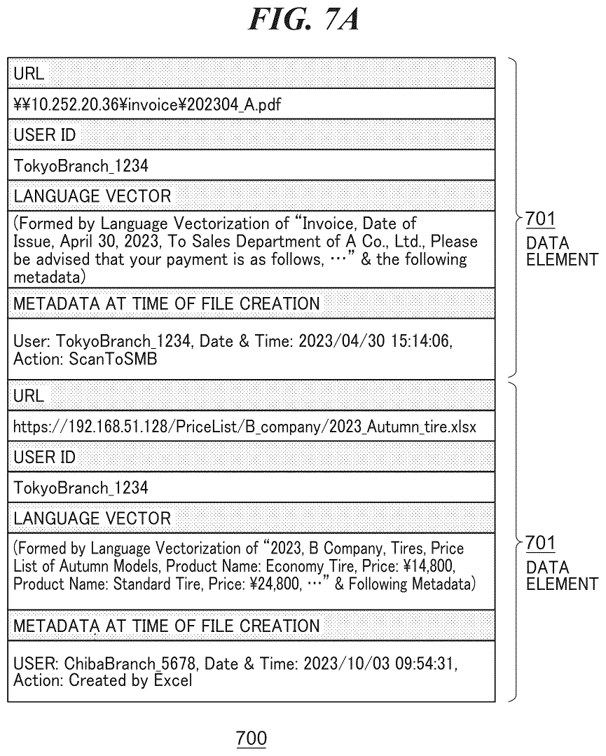

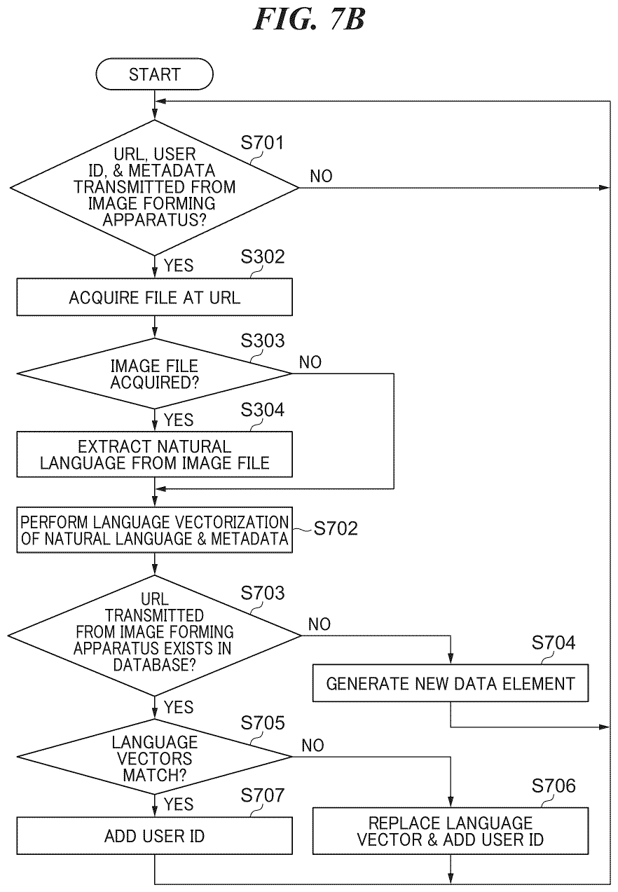

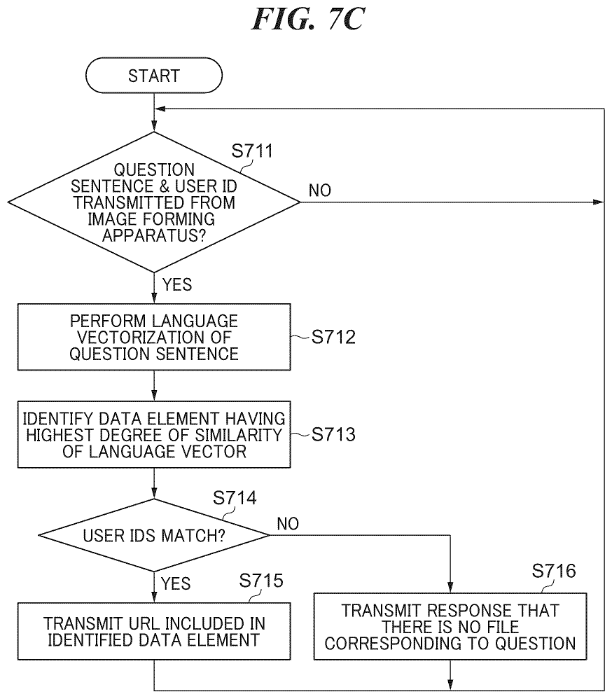

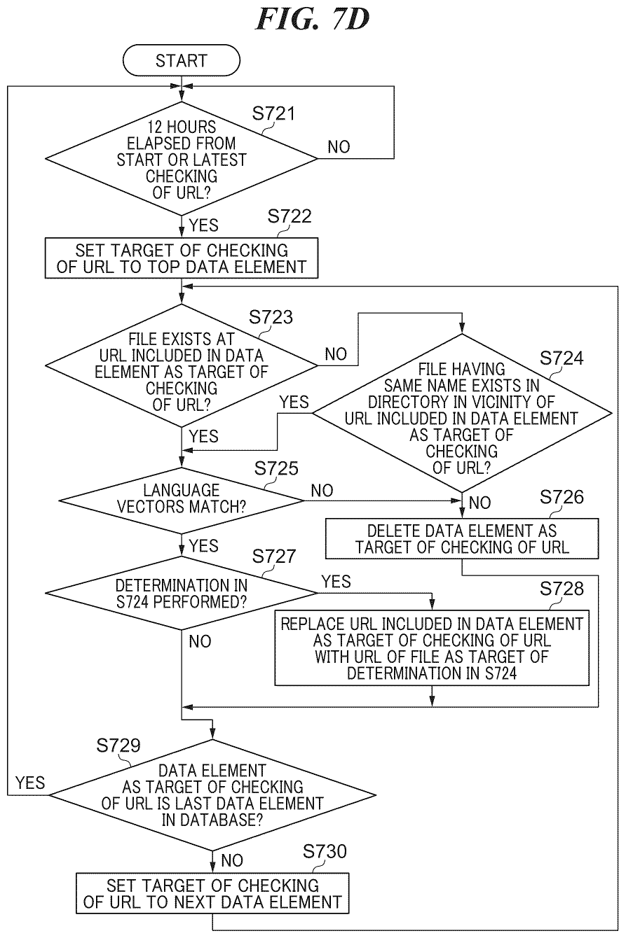

Details of the large-scale language model server 103 will be described below with reference to FIGS. 7A to 7D. FIG. 7A is a diagram showing a database 700 constructed in the large-scale language model server 103. As shown in FIG. 7A, the database 700 has a plurality of data elements 701. Each data element 701 includes four information items. The four information items include a URL indicating a storage location of one file, a user ID of a device on which an operation on the file has been performed, a language vector formed by subjecting the contents of the file to language vectorization, and metadata generated when the file has been newly created. In this point, compared with each data element 301 of the first embodiment, each data element 701 is different in that a language vector formed by subjecting the metadata generated when the file is newly created to language vectorization, and the metadata generated when this file is newly created are included in each data element 701. The metadata generated when the file is newly created includes creation date and time, a creator name, and contents of an action (creation factor). Note that in the database 700, whenever a URL is transmitted from the image forming apparatus 501 or the like to the large-scale language model in the large-scale language model server 103, update of the data element 701 and addition of a new data element 701 occur.

FIGS. 7B to 7D are flowcharts showing the operations of the large-scale language model in the large-scale language model server 103. FIG. 7B is a flowchart showing the operations of the large-scale language model server 103 in a case where when the image forming apparatus 501 performs an operation on a file, a URL of the file is transmitted to the large-scale language model server 103 by a resident program of the image forming apparatus 501. Steps of a process described with reference to FIG. 7B are realized by the CPU 201 that loads an associated program of the large-scale language model, which is stored in the HDD 204, into the RAM 203 and executes the loaded program in the large-scale language model server 103.

In a step S701, the CPU 201 of the large-scale language model server 103 determines whether or not a URL and a user ID have been transmitted from the image forming apparatus 501. Further, if the operation on a file, which is performed on the image forming apparatus 501, is an operation of newly creating a file, the CPU 201 of the large-scale language model server 103 also determines whether or not metadata generated when the file is newly created has been transmitted from the image forming apparatus 501. Note that in a case where the operation on a file, which is performed in the image forming apparatus 501, is an operation of newly creating a file, this operation can be an operation of transmitting a file created by scanning an internal document of the company to the file server 102 and storing the same therein, which is performed in the image forming apparatus 501.

If it is determined by the CPU 201 of the large-scale language model server 103 that a URL and a user ID have not been transmitted from the image forming apparatus 501, the process returns to the step S701. With this, the CPU 201 of the large-scale language model server 103 is in a state waiting for transmission of a URL and a user ID from the image forming apparatus 501. On the other hand, if it is determined by the CPU 201 of the large-scale language model server 103 that a URL and a user ID have been transmitted from the image forming apparatus 501, the process proceeds to the step S302. Note that the steps S302, S303, and S304 are the same as those of the first embodiment in FIG. 3B, and hence detailed description thereof is omitted.

In a step S702, the CPU 201 of the large-scale language model server 103 subjects the natural language included in the acquired file or the natural language extracted from the acquired file to language vectorization. Further, if metadata has been transmitted from the image forming apparatus 501, the CPU 201 of the large-scale language model server 103 also subjects the metadata to language vectorization. With this, the CPU 201 of the large-scale language model server 103 acquires the language vector of the natural language included in the acquired file or the natural language extracted from the acquired file. Further, if metadata has been transmitted from the image forming apparatus 501, the CPU 201 of the large-scale language model server 103 also acquires the language vector of the metadata.

In a step S703, the CPU 201 of the large-scale language model server 103 determines whether or not the URL transmitted from the image forming apparatus 501 exists in the database 700. This determination is performed similarly as performed by the determination in the step S306 in the first embodiment. If it is determined by the CPU 201 of the large-scale language model server 103 that the URL transmitted from the image forming apparatus 501 does not exist in the database 700, the process proceeds to a step S704. On the other hand, if it is determined by the CPU 201 of the large-scale language model server 103 that the URL transmitted from the image forming apparatus 501 exists in the database 700, the process proceeds to a step S705.

In the step S704, the CPU 201 of the large-scale language model server 103 generates a new data element 701 in the database 700. At this time, the CPU 201 of the large-scale language model server 103 combines the language vector acquired in the step S702, and the URL and the user ID, which are transmitted from the image forming apparatus 501, and causes this combination to be included in the new data element 701. Further, if metadata has been transmitted from the image forming apparatus 501, the CPU 201 of the large-scale language model server 103 also combines the metadata and causes the resulting combination to be included in the new data element 701. After that, the process returns to the step S701.

In the step S705, the CPU 201 of the large-scale language model server 103 determines whether or not a language vector included in the data element 701 together with the URL transmitted from the image forming apparatus 501 matches the language vector acquired in the step S702. If it is determined by the CPU 201 of the large-scale language model server 103 that the language vector included in the data element 701 together with the URL transmitted from the image forming apparatus 501 does not match the language vector acquired in the step S702, the process proceeds to a step S706. On the other hand, if it is determined by the CPU 201 of the large-scale language model server 103 that the language vector included in the data element 701 together with the URL transmitted from the image forming apparatus 501 matches the language vector acquired in the step S702, the process proceeds to a step S707.

In the step S706, the CPU 201 of the large-scale language model server 103 replaces the language vector combined with the URL transmitted from the image forming apparatus 501 in the data element 701 with the language vector acquired in the step S702. Further, in a case where the user ID combined with the URL transmitted from the image forming apparatus 501 in the data element 701 is different from the user ID transmitted from the image forming apparatus 501 together with the URL, the CPU 201 of the large-scale language model server 103 adds the user ID. When adding the user ID, the user ID transmitted from the image forming apparatus 501 together with the URL is added to the data element 701 including the URL transmitted from the image forming apparatus 501. After that, the process returns to the step S701. In the step S707, the CPU 201 of the large-scale language model server 103 adds the user ID similarly to the step S706. Note that in the step S707, replacement of the language vector in the step S706 is not performed. After that, the process returns to the step S701.

FIG. 7C is a flowchart showing the operations of the large-scale language model server 103 in a case where a question sentence and a user ID are transmitted to the large-scale language model server 103 by an associated resident program of the image forming apparatus 501 via the chat program. Note that the question sentence in the second embodiment is a sentence generated by using a natural language and refers to a sentence provided by a user to ask a question about a storage location of a file with description of the contents of this file or with description of the creation date and time, a creator name, and an action, at a time when the file was newly created. The operations indicated by the flowchart in FIG. 7C are realized by the CPU 201 that loads the program of the large-scale language model, which is stored in the HDD 204, into the RAM 203 and executes the loaded program in the large-scale language model server 103. The description of the steps S311 to S316 in FIG. 3C becomes the description of steps S711 to S716 in FIG. 7C when the user terminal 101, the database 300, and the data element 301 are changed to the image forming apparatus 501, the database 700, and the data element 701, respectively. Therefore, the operations indicated by the flowchart in FIG. 7C are the same as the operations indicated by the flowchart in FIG. 3C in the first embodiment except the above-mentioned point, and hence detailed description thereof is omitted.

FIG. 7D is a flowchart showing the operations of the large-scale language model server 103 in a case where the large-scale language model server 103 periodically checks whether or not a file exists at a URL in each data element 701 of the database 700. The large-scale language model server 103 periodically checks whether or not a file exists at a URL in each data element 701 of the database 700 at intervals of 12 hours. Further, if a file as a target to be confirmed at a URL exists neither at the URL nor in the vicinity of the URL in the data element 701, the large-scale language model server 103 deletes the data element 701 from the database 700. Further, if a file as the target to be confirmed to exist at the URL exists in a directory in the vicinity of the URL in the data element 701, the large-scale language model server 103 replaces the URL in this data element 701 with the URL at which the target file exists. Note that in the second embodiment, the directory in the vicinity of a URL refers to a parent directory of the directory of the URL or a directory in the same layer as the directory of the URL but is not limited to this.

The operations indicated by the flowchart in FIG. 7D are realized by the CPU 201 that loads an associated program stored in the HDD 204 into the RAM 203 and executes the loaded program in the large-scale language model server 103. In a step S721, the CPU 201 of the large-scale language model server 103 determines whether or not 12 hours have elapsed from the startup or the latest checking of a URL. Note that the CPU 201 of the large-scale language model server 103 counts 12 hours by using an incorporated clock. If it is determined by the CPU 201 of the large-scale language model server 103 that 12 hours have not elapsed from the startup or the latest checking of a URL, the process returns to the step S721. With this, the CPU 201 of the large-scale language model server 103 is in a state waiting for the lapse of 12 hours from the startup or the latest checking of a URL. On the other hand, if it is determined by the CPU 201 of the large-scale language model server 103 that 12 hours have elapsed from the startup or the latest checking of a URL, the process proceeds to a step S722.

In the step S722, the CPU 201 of the large-scale language model server 103 sets the target of the checking of a URL to the top data element 701. In a step S723, the CPU 201 (determination unit) of the large-scale language model server 103 determines whether or not a file exists at a URL included in the data element 701 set as the target of the checking of a URL. This determination is performed based on whether or not the CPU 201 of the large-scale language model server 103 has reached a file at the URL included in the data element 701 set as the target of the checking of a URL. If it is determined by the CPU 201 of the large-scale language model server 103 that a file does not exist at the URL included in the data element 701 set as the target of the checking of a URL, the process proceeds to a step S724. On the other hand, if it is determined by the CPU 201 of the large-scale language model server 103 that a file exists at the URL included in the data element 701 set as the target of the checking of a URL, the process proceeds to a step S725.

In the step S724, the CPU 201 (determination unit) of the large-scale language model server 103 determines whether or not a file having the same file name exists in a directory in the vicinity of the URL included in the data element 701 set as the target of the checking of a URL. Note that the file name is included in the URL. If it is determined by the CPU 201 of the large-scale language model server 103 that a file having the same file name exists in a directory in the vicinity of the URL included in the data element 701 set as the target of the checking of a URL, the process proceeds to the step S725. On the other hand, if it is determined by the CPU 201 of the large-scale language model server 103 that a file having the same file name does not exist in a directory in the vicinity of the URL included in the data element 701 set as the target of the checking of a URL, the process proceeds to a step S726.

In the step S725, the CPU 201 of the large-scale language model server 103 determines whether or not a language vector of the file as the target of the determination in the step S724 matches a language vector included in the data element 701 as the target of the checking of a URL. At this time, the CPU 201 of the large-scale language model server 103 acquires the file as the target of the determination in the step S724 and converts a natural language included in the acquired file to a language vector together with the metadata of this file. However, if the file as the determination target in the step S724 is an image file, the CPU 201 of the large-scale language model server 103 converts a natural language extracted from the acquired file to a language vector together with the metadata of this file. Thus, the CPU 201 of the large-scale language model server 103 acquires the language vector of the file as the target of the determination in the step S724.

If it is determined by the CPU 201 of the large-scale language model server 103 that the language vector of the file as the target of the determination in the step S724 does not match the language vector included in the data element 701 as the target of the checking of a URL, the process proceeds to the step S726. On the other hand, if it is determined by the CPU 201 of the large-scale language model server 103 that the language vector of the file as the target of the determination in the step S724 matches the language vector included in the data element 701 as the target of the checking of a URL, the process proceeds to a step S727. In the step S726, the CPU 201 (deletion unit) of the large-scale language model server 103 deletes the data element 701 as the target of the checking of a URL from the database 700. As a result, the useless data element 701 is deleted from the database 700. After that, the process proceeds to a step S729.

In the step S727, the CPU 201 of the large-scale language model server 103 determines whether or not the determination in the step S724 has been performed concerning the data element 701 as the target of the checking of a URL. If it is determined by the CPU 201 of the large-scale language model server 103 that the determination in the step S724 has been performed concerning the data element 701 as the target of the checking of a URL, the process proceeds to a step S728. On the other hand, if it is determined by the CPU 201 of the large-scale language model server 103 that the determination in the step S724 has not been performed concerning the data element 701 as the target of the checking of a URL, the process proceeds to the step S729. In the step S728, the CPU 201 (information replacement unit) of the large-scale language model server 103 replaces the URL of the data element 701 as the target of the checking of a URL with the URL of the file as the target of the determination in the step S724. With this, in the data element 701 of the database 700, a useless URL is replaced with the useful URL. Note that in a case where the determination in the step S724 has not been performed with respect to the data element 701 as the target of the checking of a URL, the URL of the data element 701 as the target of the checking of a URL is not replaced.

In the step S729, the CPU 201 of the large-scale language model server 103 determines whether or not the data element 701 set as the target of the checking of a URL is the last data element 701 in the database 700. If it is determined by the CPU 201 of the large-scale language model server 103 that the data element 701 set as the target of the checking of a URL is the last data element 701 in the database 700, the process returns to the step S721. With this, the CPU 201 of the large-scale language model server 103 is in a state waiting until 12 hours elapses from the latest checking of a URL. On the other hand, if it is determined by the CPU 201 of the large-scale language model server 103 that the data element 701 set as the target of the checking of a URL is not the last data element 701 in the database 700, the process proceeds to a step S730. In the step S730, the CPU 201 of the large-scale language model server 103 sets the target of the checking of a URL to the next data element 701. After that, the process returns to the step S723.

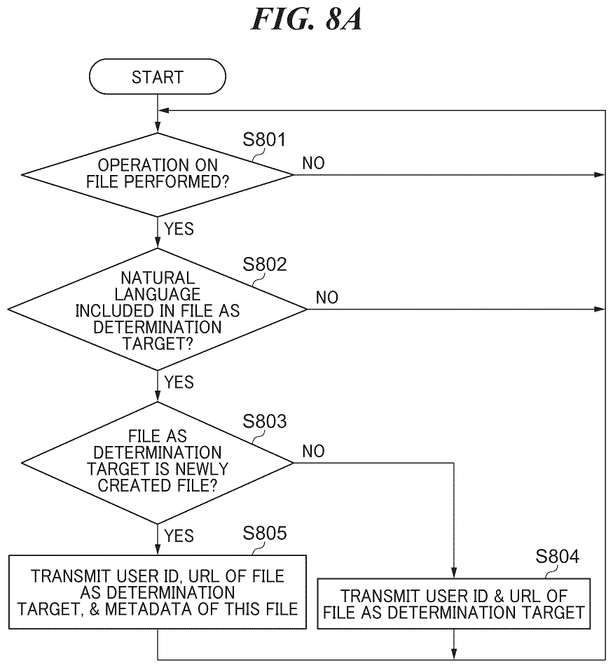

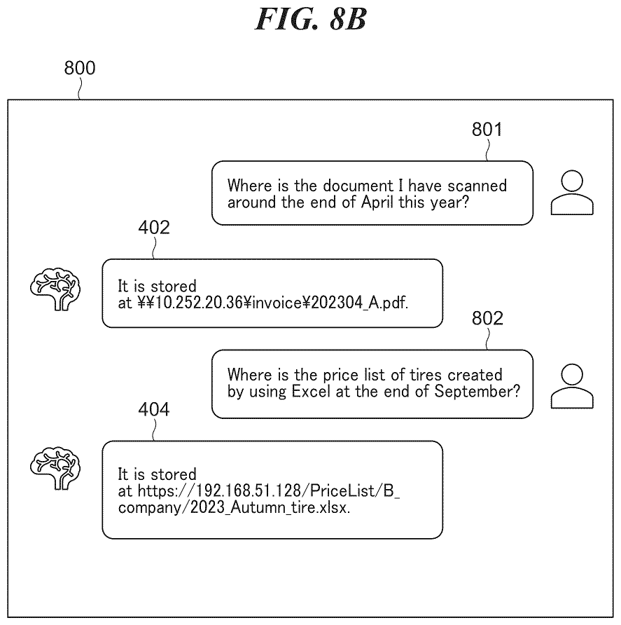

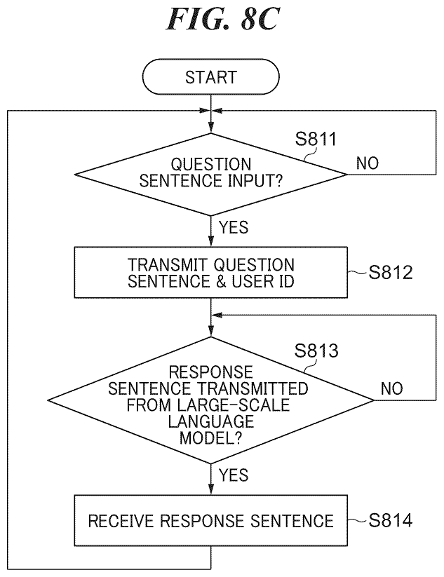

The operations of the image forming apparatus 501 will be described below with reference to FIGS. 8A to 8C. FIG. 8A is a flowchart showing the operations of the image forming apparatus 501 in a case where the image forming apparatus 501 performs an operation on a file for the image forming apparatus 501 itself, the file server 102, or the user terminal 101. The operations indicated by the flowchart in FIG. 8A are realized by the CPU 604 that loads an associated resident program stored in the storage 606 into the RAM 607 and executes the loaded program in the image forming apparatus 501.

In a step S801, the CPU 604 of the image forming apparatus 501 determines whether or not an operation on a file has been performed for the image forming apparatus 501 itself, the file server 102, or the user terminal 101. If it is determined by the CPU 604 of the image forming apparatus 501 that an operation on a file has been performed for one of the image forming apparatus 501 itself, the file server 102, and the user terminal 101, the process proceeds to a step S802. On the other hand, if it is determined by the CPU 604 of the image forming apparatus 501 that an operation on a file has been performed for none of the image forming apparatus 501 itself, the file server 102, and the user terminal 101, the process returns to the step S801. With this, the CPU 604 of the image forming apparatus 501 is in a state waiting for an operation on a file to be performed for any of the image forming apparatus 501 itself, the file server 102, and the user terminal 101.

In the step S802, the CPU 604 of the image forming apparatus 501 determines whether or not a natural language is included in the file as the determination target in the step S801. The determination method used in the step S802 is the same as the determination method used in the step S402 in the first embodiment. If it is determined by the CPU 604 of the image forming apparatus 501 that a natural language is not included in the file as the determination target in the step S801, the process returns to the step S801. On the other hand, if it is determined by the CPU 604 of the image forming apparatus 501 that a natural language is included in the file as the determination target in the step S801, the process proceeds to a step S803.

In the step S803, the CPU 604 of the image forming apparatus 501 determines whether or not the file as the determination target in the step 801 is a newly created file. If it is determined by the CPU 604 of the image forming apparatus 501 that the file as the determination target in the step 801 is not a newly created file, the process proceeds to a step S804. On the other hand, if it is determined by the CPU 604 of the image forming apparatus 501 that the file as the determination target in the step S801 is a newly created file, the process proceeds to a step S805.

In the step S804, the CPU 604 (transmission unit) of the image forming apparatus 501 transmits the user ID and the URL of the file as the determination target in the step S801 to the large-scale language model server 103. After that, the process returns to the step S801. In the step S805, the CPU 604 (transmission unit) of the image forming apparatus 501 transmits the user ID, the URL of the file as the determination target in the step S801, and further, the metadata generated when this file has been newly created to the large-scale language model server 103. After that, the process returns to the step S801.

FIG. 8B is a diagram showing a screen 800 displayed on the console section 603 of the image forming apparatus 501 when the image forming apparatus 501 transmits a question sentence about a storage location of a file to the large-scale language model server 103. Note that in the image forming apparatus 501, the screen 800 is displayed on the console section 603 by a chat program. An example of a text chat exchanged between the user of the image forming apparatus 501 and the large-scale language model in the large-scale language model server 103 will be described below with reference to the screen 800 shown in FIG. 8B. A question sentence displayed on the screen 800 is provided with not only a description of the contents of the file, but also a description of how the file has been created or with a description formed by adding how the file has been created to the contents of the file. This point is different from the question sentence displayed on the screen 400 in the first embodiment.

As shown in the screen 800 in FIG. 8B, the user asks a question about the storage location of an invoice to Company A for April this year to the large-scale language model in a sentence in the conversational tone using a natural language through a chat comment 801. However, this question is provided only with a creation time, a creator name, and an action at a time when the file was newly created. In response to this question, the large-scale language model makes a response for notifying the user of a URL of a shared folder in the file server 102 as the storage location of the invoice to Company A for April this year to the user in a sentence in the conversational tone using the natural language through the chat comment 402.

Further, the user asks a question about the storage location of a price list of tires of Company B in the autumn of 2023 to the large-scale language model in a sentence in the conversational tone using the natural language through a chat comment 802. However, this question is provided with not only a description of the creation time and the action at a time when the file was newly created, but also the contents of the file. In response to this question, the large-scale language model makes a response for notifying the user of a URL in the HTTP server, not shown, as the storage location of the price list of tires of Company B in the autumn of 2023 to the user in a sentence in the conversational tone using the natural language through the chat comment 404. Note that a communication protocol indicated by the scheme of the URL in the chat comment 404 is the HTTP. Therefore, the HTTP server, not shown, provides the file to the image forming apparatus 501, the large-scale language model server 103, and the user terminal 101, by the HTTP communication protocol via the network 105. Further, similar to the file server 102, the HTTP server, not shown, has the hardware configuration shown in FIG. 2.

FIG. 8C is a flowchart showing the operations of the image forming apparatus 501 in a case where a question sentence and a user ID are transmitted to the large-scale language model server 103 by an associated resident program of the image forming apparatus 501 via the chat program. Steps of a process shown in FIG. 8C (method of controlling the information processing apparatus) are realized by the CPU 604 (computer) that loads an associated resident program (program) stored in the storage 606 into the RAM 607 and executes the loaded program in the image forming apparatus 501. The description of FIG. 4C becomes the description of FIG. 8C when the user terminal 101, the CPU 201, the screen 400, and the chat comments 401 and 403 are changed to the image forming apparatus 501, the CPU 604, the screen 800, and the chat comments 801 and 802, respectively. Therefore, the operations in steps S811 to S814 in FIG. 8C are the same as the operations in the steps S411 to S414 in FIG. 4C in the first embodiment except the above-mentioned points, and hence detailed description thereof is omitted.

As described above, in the second embodiment, in the information processing system 500 and the image forming apparatus 501, it is also possible to easily retrieve a URL as the information indicating a storage location of a file without being restricted by the process how the file has been stored on the network 105. With this, in the image forming apparatus 501, when a user desires to print e.g. an internal document of the company which was scanned in the past, the user can retrieve the URL indicating the storage location of the file of this internal document using the natural language. At this time, the user can also retrieve the URL indicating the storage location of the file by using a question sentence including not only the description of the contents of the file, but also description of the creation time, the creator name, the action, and so forth, at a time when the file was newly created.

For example, in the second embodiment, the image forming apparatus 501 is a multifunction peripheral (MFP) integrally equipped with the scan function, the copy function, and the communication function, but can be an apparatus further integrally equipped with other functions. Further, the image forming apparatus 501 can be an apparatus integrally equipped with the scan function and the communication function. Further, in the second embodiment, the metadata at a time when a file is newly created includes information on creation date and time, a creator name, and an action, but can include at least one of these items or can include an item other than these.

Further, in the second embodiment, the user terminal 101 can also retrieve a URL indicating a storage location of a file similarly to the image forming apparatus 501. Therefore, the user terminal 101 can perform retrieval with respect to a file stored in a device on the network 105 by the user terminal 101 itself and perform retrieval with respect to a file stored in a device on the network 105 by the image forming apparatus 501. Further, the flowchart in FIG. 7D in the second embodiment can also be applied in the first embodiment. Further, the invention related to the metadata in the second embodiment can also be applied in the first embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009369 filed Jan. 25, 2024, which is hereby incorporated by reference herein in its entirety.

What is claimed is:

1. An information processing apparatus, comprising:
at least one processor; and
a memory coupled to the at least one processor storing instructions that, when executed by the processor, cause the processor to function as:
a message transmission unit configured to transmit a question message using a natural language for inquiring about a storage location of a file to a large-scale language model in a server, wherein the large-scale language model is a large-scale language model that retrieves information indicating a storage location of a file based on a degree of similarity of a language vector of the natural language; and
a message reception unit configured to receive a response message for notifying the information indicating the storage location of the file from the large-scale language model, which has been retrieved by the large-scale language model by using the language vector of the natural language of the question message.

2. The information processing apparatus according to claim 1, wherein the message transmission unit and the message reception unit each use a text chat exchanged with the large-scale language model.

3. The information processing apparatus according to claim 1, wherein the processor is caused to further function as a transmission unit configured to transmit, in a case where an operation on the file has been performed for a device connected to a network, the information indicating the storage location of the file to the large-scale language model.

4. The information processing apparatus according to claim 3, wherein the transmission unit transmits the information indicating the storage location of the file to the large-scale language model only in a case where the natural language is included in the file.

5. The information processing apparatus according to claim 3, wherein the transmission unit transmits a user ID to the large-scale language model together with the information indicating the storage location of the file,
wherein the message transmission unit transmits a user ID to the large-scale language model together with the question message, and
wherein in a case where a user ID transmitted to the large-scale language model together with the information indicating the storage location of the file, which has been retrieved by the large-scale language model by using the language vector of the natural language of the question message, and a user ID transmitted to the large-scale language model together with the question message match each other, the message reception unit receives the response message.

6. The information processing apparatus according to claim 5, wherein in a case where the user ID transmitted to the large-scale language model together with the information indicating the storage location of the file, which has been retrieved by the large-scale language model by using the language vector of the natural language of the question message, and the user ID transmitted to the large-scale language model together with the question message do not match each other, the message reception unit receives a message that the file does not exist in place of the response message.

7. The information processing apparatus according to claim 3, wherein in a case where the operation on the file is an operation of newly creating a file, the transmission unit transmits metadata of the file to the large-scale language model together with the information indicating the storage location of the file so as to cause the large-scale language model to perform search using a language vector of the metadata of the file.

8. The information processing apparatus according to claim 7, wherein the metadata of the file is at least one of creation date and time, a creator name, and a creation factor of the file.

9. The information processing apparatus according to claim 1, wherein the information indicating the storage location of the file is a uniform resource locator (URL).

10. The information processing apparatus according to claim 9, wherein a communication protocol indicated by a scheme of the URL is Hyper Text Transfer Protocol (HTTP).

11. The information processing apparatus according to claim 9, wherein a communication protocol indicated by a scheme of the URL is the Server Message Block (SMB).

12. The information processing apparatus according to claim 1, wherein the information processing apparatus is a personal computer (PC).

13. The information processing apparatus according to claim 1, wherein the information processing apparatus is an image forming apparatus.

14. The information processing apparatus according to claim 1, wherein the file is a document file.

15. The information processing apparatus according to claim 1, wherein the file is an image file including the natural language.

16. A method of controlling an information processing apparatus, comprising:
transmitting a question message using a natural language for inquiring about a storage location of a file to a large-scale language model in a server, wherein the large-scale language model is a large-scale language model that retrieves information indicating a storage location of a file based on a degree of similarity of a language vector of the natural language; and
receiving a response message for notifying the information indicating the storage location of the file from the large-scale language model, which has been retrieved by the large-scale language model by using the language vector of the natural language of the question message.

17. A non-transitory computer-readable storage medium storing a program for causing a computer to execute a method of controlling an information processing apparatus,
wherein the method comprises:
transmitting a question message using a natural language for inquiring about a storage location of a file to a large-scale language model in a server, wherein the large-scale language model is a large-scale language model that retrieves information indicating a storage location of a file based on a degree of similarity of a language vector of the natural language; and
receiving a response message for notifying the information indicating the storage location of the file from the large-scale language model, which has been retrieved by the large-scale language model by using the language vector of the natural language of the question message.
